(19) United States
(12) Patent Application Publication
(10) Pub. No.: US 2023/0401810 A1
(43) Pub. Date: Dec. 14, 2023

(54) ARTIFICIAL INTELLIGENCE (AI)-BASED SYSTEM AND METHOD FOR MONITORING HEALTH CONDITIONS

(71) Applicant: MYANIML, Overland Park, KS (US)

(72) Inventors: Nathan D Leiker, Hays, KS (US); Shekhar Gupta, Overland Park, KS (US); Saroj Gupta, Overland Park, KS (US)

(21) Appl. No.: 17/835,015

(22) Filed: Jun. 8, 2022

(51) Int. Cl. G06V 10/25; G06F 16/487; G06F 16/432; A61D 17/00

(52) U.S. Cl. CPC G06V 10/25; A61D 17/006; G06F 16/434; G06F 16/487

(57) ABSTRACT

An AI-based system and method for monitoring health conditions is disclosed. The method includes capturing at real-time a multimedia data of a ROI and identifying location of one or more image capturing devices. The method includes identifying one or more proximal mobile servers in proximity to the ROI, retrieving one or more ROI parameters from a storage unit and determining one or more travel. Furthermore, the method includes establishing a communication session between the one or more image capturing devices and the set of most optimal mobile servers upon, generating a command by analyzing the retrieved one or more ROI parameters, the identified location of the one or more image capturing devices and the determined one or more travel parameters by using a data management-based AI model and performing the one or more operations for monitoring health conditions of one or more animals based on the generated command.

### FIELD OF INVENTION

Embodiments of the present disclosure relate to Artificial Intelligence (AI)-based systems and more particularly relates to a system and a method for monitoring health conditions.

### BACKGROUND

Generally, in a farm area, a rancher is required to capture images of cattle via one or more devices, such as one or more image capturing devices, and upload the captured images on a central server to diagnose the cattle. The rancher usually uploads the captured images on the central servers from the farm area or upon reaching home. However, asking the rancher to capture images on a daily basis and uploading the captured images from the farm area or upon reaching the home, isn't a viable solution as the ranchers already have long working hours. Thus, a solution is required which considers the long working hours of the ranchers and eases their workload despite of increasing it. Further, there are multiple locations, such as rural areas, where cellular coverage, interact or a combination thereof is not available or badly covered. Thus, it is very difficult to retrieve data from the one or more devices placed at the multiple locations to upload the retrieved data at the central server for processing it. Furthermore, if the captured images are not uploaded on the central server on time, it may be difficult to provide notifications associated with the captured images, such as diagnosis information, on time. Further, even if the cellular connection exists in the multiple locations, it doesn't allow large sets of data, such as large picture and videos, to be uploaded on the central server using the cellular connection.

Hence, there is a need for an improved Artificial Intelligence (AI)-based system and method for monitoring health conditions, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an Artificial Intelligence (AI)-based computing system for monitoring health conditions is disclosed. The AI-based computing system includes one or more hardware processors and a memory coupled to the one or more hardware processors. The memory includes a plurality of modules in the form of programmable instructions executable by the one or more hardware processors. The plurality of modules include a data capturing module configured to capture at real-time a multimedia data of a Region of Interest (ROI) via one or more image capturing devices located at specified locations of the ROI. The multimedia data is indicative of health of one or more animals. The ROI includes one or more locations at which the one or more animals are placed. The one or more image capturing devices are configured to capture the multi-media data from one or more proximal mobile servers upon navigating the one or more optimal mobile servers to location of the ROI. The plurality of modules also include a location identification module configured to identify location of the one or more image capturing devices based on the captured real-time multimedia data The plurality of modules also include a server identification module configured to identify the one or more proximal mobile servers in proximity to the ROI based on the identified location of the one or more image capturing devices. The plurality of modules includes a parameter retrieval module configured to retrieve one or more ROI parameters from a storage unit upon identifying the one or more proximal mobile servers. The one or more ROI parameters include: a location of the ROI, one or more images of the one or more image capturing devices, type of the identified one or more proximal mobile servers and layout of the ROI. Further, the plurality of modules includes a parameter determination module configured to determine one or more travel parameters based on predefined location information, a current location of the one or more proximal mobile servers, the identified location of the one or more image capturing devices, and the retrieved one or more ROI parameters by using a data management-based AI model. The one or more travel parameters include: a distance between the identified one or more proximal mobile servers and the ROI, optimal path and a set of most optimal mobile servers from the identified one or more proximal mobile servers to reach the ROI. Furthermore, the plurality of modules include a session establishing module configured to establish a communication session between the one or more image capturing devices and the set of most optimal mobile servers upon determining the one or more travel parameters. The plurality of modules also include a command generation module configured to generate a command by analyzing the retrieved one or more ROI parameters, the identified location of the one or more image capturing devices and the determined one or more travel parameters by using the data management-based AI model. The generated command is transferred to the set of most optimal mobile servers for performing one or more operations. Further, the plurality of modules include an operation performing module configured to perform the one or more operations for monitoring health conditions of the one or more animals based on the generated command.

In accordance with another embodiment of the present disclosure, an AI-based method for monitoring health conditions is disclosed. The AI-based method includes capturing at real-time a multimedia data of a ROI via one or more image capturing devices located at specified locations of the ROI. The multimedia data is indicative of health of one or more animals. The ROI includes one or more locations at which the one or more animals are placed. The one or more image capturing devices are configured to capture the multi-media data from one or more proximal mobile servers upon navigating the one or more optimal mobile servers to location of the ROI. The AI-based method includes identifying location of the one or more image capturing devices based on the captured real-time multimedia data. The AI-based method further includes identifying the one or more proximal mobile servers in proximity to the ROI based on the identified location of the one or more image capturing devices. Further, the AI-based method includes retrieving one or more ROI parameters from a storage unit upon identifying the one or more proximal mobile servers. The one or more ROI parameters include: a location of the ROI, one or more images of the one or more image capturing devices, type of the identified one or more proximal mobile servers and layout of the ROI. Also, the AI-based method includes determining one or more travel parameters based on predefined location information, a current location of the one or more proximal mobile servers, the identified location of the one or more image capturing devices and the retrieved one or more ROI parameters by using a data management-based AI model. The one or more travel parameters include: a distance between the identified one or more proximal mobile servers and the ROI, optimal path and a set of most optimal mobile servers from the identified one or more proximal mobile servers to reach the ROI. The AI-based method includes establishing a communication session between the one or more image capturing devices and the set of most optimal mobile servers upon determining the one or more travel parameters. Furthermore, the AI-based method includes generating a command by analyzing the retrieved one or more ROI parameters, the identified location of the one or more image capturing devices and the determined one or more travel parameters by using the data management-based AI model. The generated command is transferred to the set of most optimal mobile servers for performing one or more operations. Further, the AI-based method includes performing the one or more operations for monitoring health conditions of the one or more animals based on the generated command.

Embodiment of the present disclosure also provide a non-transitory computer-readable storage medium having instructions stored therein that, when executed by a hardware processor, cause the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment for monitoring health conditions, in accordance with an embodiment of the present disclosure;

FIG. 2 is a block diagram illustrating an exemplary AI-based computing system for monitoring health conditions, in accordance with an embodiment of the present disclosure;

FIG. 3 is a process flow diagram illustrating an exemplary AI-based method for monitoring health conditions, in accordance with an embodiment of the present disclosure; and

FIGS. 4A-4B are pictorial depiction illustrating location of image capturing devices, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

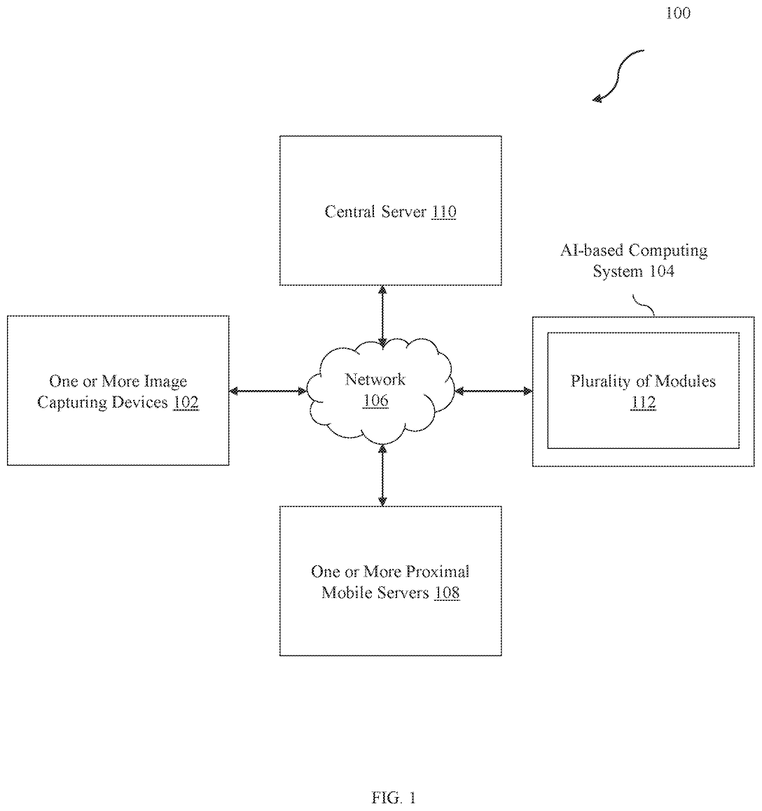

Referring now to the drawings, and more particularly to FIG. 1 through FIG. 4B, where similar reference characters denote corresponding features consistently throughout the figures, there are shown preferred embodiments and these embodiments are described in the context of the following exemplary system and/or method.

FIG. 1 is a block diagram illustrating an exemplary computing environment 100 for monitoring health conditions, in accordance with an embodiment of the present disclosure. According to FIG. 1, the computing environment 100 includes one or more image capturing devices 102 communicatively coupled to an Artificial Intelligence (Ai)-based computing system 104 via a network 106. The one or more image capturing devices 102 may include a set of cameras to capture multimedia data corresponding to a Region of Interest (ROI). In an exemplary embodiment of the present disclosure, the set of cameras include a stationary camera, a movable camera or a combination thereof. For example, the ROI may be one or more farm areas. In an exemplary embodiment of the present disclosure, the multimedia data may include a plurality of images and a plurality of videos corresponding to the ROI. The plurality of images and the plurality of videos may be of cattle in the one or more farm areas. The one or more image capturing devices 102 are located at a water pond, next to the water pond, submerged in the water pond, a feeder truck, trailer, pathway to the trailer, loading ramp, unloading ramp, walkway to milking parlor, one or more milking booths, a parlor's railings, a standalone object, body of cattle, cattle horses, dogs, chute, a walkway to the chute, a pen, a vehicle, a user or any combination thereof. For example, the user may be a rancher. The network 106 may be an internet connection or any other wired or wireless network. In an embodiment of the present disclosure, the AI-based computing system 104 may correspond to one or more proximal mobile servers 108. In another embodiment of the present disclosure, the AI-based computing system 104 may be hosted on a central server 110, such as cloud server or a remote server. In an embodiment of the present disclosure, the one or more image capturing devices 102 may directly upload the captured multimedia data to the central server 110, one or more on-premises devices or a combination thereof.

Further, the computing environment 100 includes the one or more proximal mobile servers 108 communicatively coupled to the AI-based computing system 104 via the network 106. The one or more proximal mobile servers 108 uploads the multimedia data from the one or more image capturing devices 102 located in the ROI to a central server 110, one or more on-premises devices or a combination thereof. For example, the one or more proximal mobile servers 108 include one or more drones, one or more water-surface robots, one or more land robots, one or more under-water robots or a combination thereof. In an embodiment of the present disclosure, the central server 110 processes the uploaded multimedia data for generating one or more notifications corresponding to diagnosis of cattle, predicting diseases in cattle and the like. In an embodiment of the present disclosure, the one or more notifications are outputted on one or more user devices associated with the user. In an exemplary embodiment of the present disclosure, the one or more user devices may include a laptop computer, desktop computer, tablet computer, smartphone, wearable device, smart watch, a digital camera and the like.

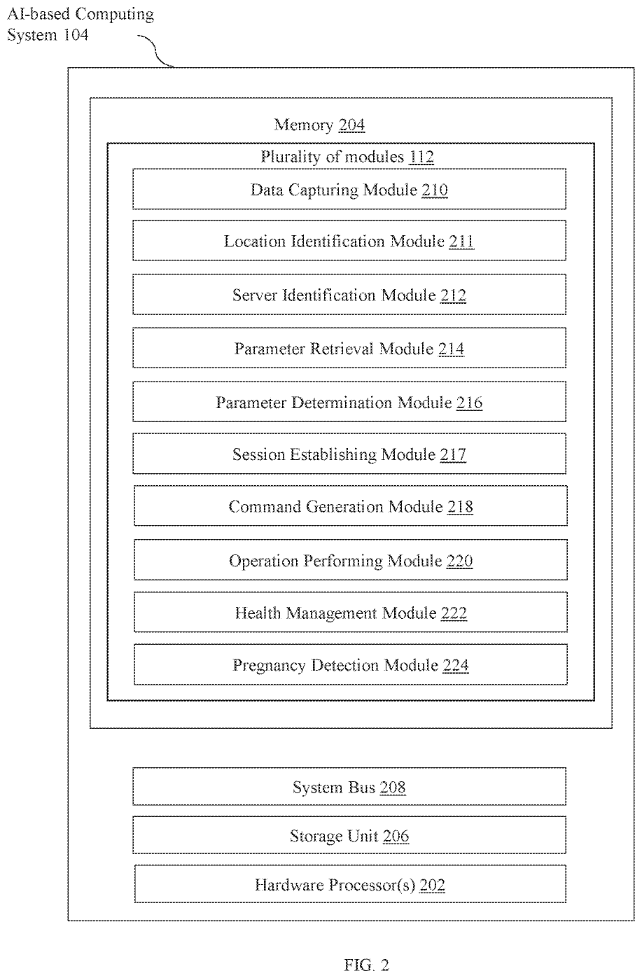

Furthermore, the one or more user devices include a local browser, a mobile application or a combination thereof. Furthermore, the user may use a web application via the local browser, the mobile application or a combination thereof to communicate with the AI-based computing system 104 and receive the one or more notifications. In an exemplary embodiment of the present disclosure, the mobile application may be compatible with any mobile operating system, such as android, iOS, and the like. In an embodiment of the present disclosure, the AI-based computing system 104 includes a plurality of modules 112. Details on the plurality of modules 112 have been elaborated in subsequent paragraphs of the present description with reference to FIG. 2.

In an embodiment of the present disclosure, the AI-based computing system 104 is configured to capture at real-time a multimedia data of a ROI via the one or more image capturing devices located at specified locations of the ROI. The AI-based computing system 104 identifies location of the one or more image capturing devices based on the captured real-time multimedia data. Further, the AI-based computing system 104 identifies the one or more proximal mobile servers 108 in proximity to the ROI based on the identified location of the one or more image capturing devices. The AI-based computing system 104 retrieves one or more ROI parameters from a storage unit upon identifying the one or more proximal mobile servers 108. Furthermore, the AI-based computing system 104 determines one or more travel parameters based on predefined location information, a current location of the one or more proximal mobile servers 108, the identified location of the one or more image capturing devices, and the retrieved one or more ROI parameters by using a data management-based AI model. The AI-based computing system establishes a communication session between the one or more image capturing devices and the set of most optimal mobile servers upon determining the one or more travel parameters. The AI-based computing system 104 generates a command by analyzing the retrieved one or more ROI parameters, the identified location of the one or more image capturing devices 102 and the determined one or more travel parameters by using the data management-based AI model. Further, the AI-based computing system 104 to performs one or more operations for monitoring health conditions of the one or more animals based on the generated command.

FIG. 2 is a block diagram illustrating an exemplary AI-based computing system 104 for monitoring health conditions, in accordance with an embodiment of the present disclosure. Further, the AI-based computing system 104 includes one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 112 in the form of programmable instructions executable by the one or more hardware processors 202. Further, the plurality of modules 112 includes a data capturing module 210, a location identification module 211, a server identification module 212, a parameter retrieval module 214, a parameter determination module 216, a session establishing module 217, a command generation module 218, an operation performing module 220, a health management module 222 and a pregnancy detection module 224.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 112 stored in the form of machine-readable instructions on any of the above-mentioned storage media and may be in communication with and executed by the one or more hardware processors 202.

In an embodiment of the present disclosure, the storage unit 206 may be a cloud storage. The storage unit 206 may store the one or more ROI parameters, the one or more travel parameters, the generated command, the multimedia data, the predefined location information, a set of real-time images, a set of real-time videos, an exact location of the one or more image capturing devices 102, one or more location parameters, one or more distance parameters, one or more predefined locations, current location of the set of most optimal mobile servers and the like.

The data capturing module 210 is configured to capture at real-time the multimedia data of the ROI via the one or more image capturing devices 102 located at specified locations of the ROI. In an embodiment of the present disclosure, the multimedia data is indicative of health of one or more animals. The ROI includes one or more locations at which the one or more animals are placed. In an exemplary embodiment of the present disclosure, the one or more animals include cow, cat, dog, horse and the like. In an embodiment of the present disclosure, the one or more image capturing devices 102 are configured to capture the multi-media data from one or more proximal mobile servers 108 upon navigating the one or more optimal mobile servers to location of the ROI. The one or more image capturing devices 102 may include a set of cameras to capture multimedia data corresponding to ROI. In an exemplary embodiment of the present disclosure, the set of cameras include a stationary camera, a movable or mobile camera or a combination thereof. For example, the one or more image capturing devices 102 may include optical cameras, thermos cameras, Virtual Reality (VR) cameras, three-dimensional (3D) cameras, or any combination thereof or any other imaging source. In an embodiment of the present disclosure, the one or more image capturing devices 102 are connection ready, such as Wireless Fidelity (Wi-Fi) or Bluetooth enabled, either built in or connecting to other device that makes them connection ready. In an exemplary embodiment of the present disclosure, the ROI may be one or more farm areas. The one or more farm areas correspond to dairy, beef or a combination thereof. In an exemplary embodiment of the present disclosure, the multimedia data may include a plurality of images and a plurality of videos corresponding to the ROI. The plurality of images and the plurality of videos may be of cattle in the one or more farm areas. In an embodiment of the present disclosure, the plurality of images and the plurality of videos are uploaded to the central server 110 to predict, detect health of the cattle, and the like. For example, main cattle operations are dairy farm, feedlots, backgrounders, processors, producers, calf or cow operators or any combination thereof. In an exemplary embodiment of the present disclosure, the one or more image capturing devices 102 are located at a water pond, next to the water pond, submerged in the water pond, a feeder truck, trailer, pathway to the trailer, loading ramp, unloading ramp, walkway to milking parlor, one or more milking booths, a parlor's railings, a standalone object, body of cattle, an animal, chute, a walkway to the chute, a pen, a vehicle, a user or any combination thereof. Chute is a place where the cattle is brought in for inspections, any vaccines and the like. The pen is a structure where cows are held. The one or more image capturing devices 102 are installed in the pen either permanently or temporarily to capture the multimedia data. The pen may be indoors and outdoors. In an exemplary embodiment of the present disclosure, the vehicle may be jeep, tractor, All-Terrain. Vehicle (ATV) and the like. The animal may be cattle, horse, dog and the like. For example, the user may be a rancher. For example, the one or more image capturing devices 102 may be attached to body of cows for capturing the multimedia data. In an embodiment of the present disclosure, the one or more image capturing devices 102 are customized, off-the shelf or a combination thereof. In the water pond, the one or more image capturing devices 102 are permanent or temporary. In an embodiment of the present disclosure, the feeder truck include feedlot, backgrounders feeder truck and the like used for feeding the cattle. For example, the one or more image capturing devices 102 may resemble a wearable camera, such as a GoPro that is configured and trained to take pictures of a cow's face, such that the one or more image capturing devices 102 may capture the cow's face whenever it is visible.

In an embodiment of the present disclosure, in loading or unloading zones, as cattle come in, a camera may be placed to take pictures or videos of cattle getting loaded and unloaded. The captured pictures or videos may be used to detect sick cattle. For example, determining Bovine Respiratory Disease (BRD), which is a very costly disease in cattle industry. Further, the one or more image capturing devices 102 may be placed at the walkway to the milking parlor, at each milking booth, mobile cameras to go from one milking booth to another for capturing pictures or videos of the cattle or any combination thereof.

The location identification module 211 is configured to identify location of the one or more image capturing devices 102 based on the captured real-time multimedia data.

The server identification module 212 is configured to identify the one or more proximal mobile servers 108 in proximity to the ROI based on the identified location of the one or more image capturing devices 102. For example, the one or more proximal mobile servers 108 include one or more drones, one or more water-surface robots, one or more land robots, one or more under-water robots or a combination thereof. In an embodiment of the present disclosure, the one or more proximal mobile servers 108 are self-driven. For example, the one or more proximal mobile servers 108 are released by a person or may be placed in a vehicle to be driven around or attached to some structure to be moved around, such as on the railing. The one or more proximal mobile servers 108 may go up and down on the railing.

The parameter retrieval module 214 is configured to retrieve the one or more ROI parameters from the storage unit 206 upon identifying the one or more proximal mobile servers 108. In an exemplary embodiment of the present disclosure, the one or more ROI parameters include a location of the ROI, one or more images of the one or more image capturing devices 102, type of the identified one or more proximal mobile servers 108, layout of the ROI and the like. In an embodiment of the present disclosure, current location of the identified one or more proximal mobile servers 108 may be identified by using one or more Global Positioning Systems (GPSs). In an embodiment of the present disclosure, the one or more images of the one or more image capturing devices 102 are retrieved to identify the one or more image capturing devices 102 at the ROI.

The parameter determination module 216 is configured to determine the one or more travel parameters based on predefined location information, the current location of the one or more proximal mobile servers 108, the identified location of the one or more image capturing devices 102 and the retrieved one or more ROI parameters by using a data management-based AI model. In an exemplary embodiment of the present disclosure, the one or more travel parameters include distance between the identified one or more proximal mobile servers 108 and the ROI, optimal path, a set of most optimal mobile servers from the identified one or more proximal mobile servers 108 to reach the ROI and the like. For example, when the predefined location information associated with the ROI discloses that the ROI is near a lake, the set of most optimal mobile servers may be the one or more water-surface robots, the one or more under-water robots or a combination thereof.

The session establishing module 217 is configured to establish a communication session between the one or more image capturing devices 102 and the set of most optimal mobile servers upon determining the one or more travel parameters.

The command generation module 218 is configured to generate the command by analyzing the retrieved one or more ROI parameters, the identified location of the one or more image capturing devices and the determined one or more travel parameters by using the data management-based AI model. The generated command is transferred to the set of most optimal mobile servers for performing one or more operations.

The operation performing module 220 is configured to perform the one or more operations for monitoring health conditions of the one or more animals based on the generated command. In performing the one or more operations for monitoring the health conditions of the one or more animals based on the generated command, the operation performing module 220 navigate the set of most optimal mobile servers from the current location of the set of most optimal mobile servers to the location of the one or more image capturing devices 102 based on the generated command. Further, the operation performing module 220 transfers the multimedia data from the one or more image capturing devices 102 to a central server 110, one or more on-premises devices or a combination thereof based on the generated command. In an exemplary embodiment of the present disclosure, the multimedia data includes the plurality of images and the plurality of videos corresponding to the ROI. Further, the operation performing module 220 retrieves the multimedia data, from the one or more image capturing devices 102 via the set of optimal mobile servers by using one or more wired means, one or more wireless means or a combination thereof upon navigating the set of most optimal mobile servers to the one or more image capturing devices. The operation performing module 220 uploads the retrieved multimedia data to the central server 110, the one or more on-premises devices or a combination thereof via the set of most optimal mobile servers.

In an embodiment of the present disclosure, the location identification module 211 is configured to receive a set of real-time images and a set of real-time videos corresponding to the one or more image capturing devices 102 from the set of most optimal mobile servers upon navigating the set of most optimal mobile servers to the location of the ROI. Further, the location identification module 211 detects an exact location of the one or more image capturing devices 102 in the ROI based on the received set of real-time images, the received set of real-time videos, the retrieved one or more ROI parameters, a set of predefined location coordinates of the one or more image capturing devices 102 and the determined one or more travel parameters by using the data management-based AI model. For example, the one or more proximal mobile servers 108 are trained to detect the exact location of the one or more image capturing devices 102 by feeding information and the layout of the ROI. Further, the one or more proximal mobile servers 108 may also move by itself at the ROI based on the set of predefined location coordinates of the one or more image capturing devices 102 as the one or more proximal mobile servers 108 are programmed to connect to each of the one or more image capturing devices 102 to retrieve the multimedia data via wireless or wired methods. In an embodiment of the present disclosure, the one or more image capturing devices 102 and the one or more proximal mobile servers 108 are trained to recognize each other. In an embodiment of the present disclosure, a package is provided for a customer based on number of the one or more image capture devices and number of the one or more proximal mobile servers required. The one or more image capture devices and the one or more proximal mobile servers may be configured to use one or more technologies to detect where next image capturing device is placed. In an exemplary embodiment of the present disclosure, the one or more technologies include frequency associated with the one or more image capturing devices, Bluetooth, homing beacon, or some other wireless technology. Further, a map of the ROI, such as ranch, may also guide the one or more proximal mobile servers to move from one image capturing device to another image capturing device.

In uploading the multimedia data from the one or more image capturing devices 102 located in the ROI to the central server 110, one or more on-premises devices or a combination thereof upon navigating the set of most optimal mobile servers to the location of the ROI, the operation performing module 220 retrieves the multimedia data from the one or more image capturing devices 102 via the set of optimal mobile servers by using one or more wired means and one or more wireless means upon detecting the exact location of the one or more image capturing devices 102. In an exemplary embodiment of the present disclosure, the one or more wireless means include cellular means, Wi-Fi, Bluetooth, Long-Range Navigation (LORAN) or a combination thereof. In an exemplary embodiment of the present disclosure, the one or more wired means include Universal Serial Bus (USB), High-Definition Multimedia Interface (HDMI), cable, a memory card and the like. For example, a flying or mobile server, such as a robot connects with a camera either wirelessly using multiple wireless technologies available and download the multimedia data from the camera or trained to connect with the camera by attaching a wire on the camera output port, such as USB to download the multimedia data. In an embodiment of the present disclosure, the multimedia data is retrieved at a regular interval, such as twice, thrice a day or every few hours. Further, the operation performing module 220 uploads the retrieved multimedia data to the central server 110, the one or more on-premises devices or a combination thereof via the set of most optimal mobile servers. For example, the wired method is either connecting with the USB, the HDMI or any type of cable as required. In an embodiment of the present disclosure, the set of most optimal mobile servers may take the memory card out of the one or more image capturing devices 102 and install within itself to download multimedia data, deposit the memory card in its storage pouch and install a new memory card to be used by the one or more image capturing devices 102 or a combination thereof. The one or more optimal mobile servers may come back with memory cards in the storage pouch and the downloaded multimedia data is sent to the central server 110 for processing. In another example, the one or more proximal mobile servers 108 corresponds to a wearable device attached to the cow. Since the cow moves to multiple locations where the one or more image capturing devices 102 are installed, the wearable device may act as a mobile server and retrieve the multimedia data wirelessly. The one or more image capturing devices 102 may also be in the form of a wearable device, which may be worn by the user. In an embodiment of the present disclosure, the wearable device may be Extended Reality (XR) device. The user wear the wearable device and walk around in the ranch and the wearable device captures images and videos to analyse the captured images and videos for health and well-being purposes. The wearable devices may also predict and notify the user what animal may get sick.

In an embodiment of the present disclosure, the one or more image capturing devices 102 are also configured to capture at real-time the multimedia data of the ROI. Further, the one or more image capturing devices 102 uploads the retrieved multimedia data to the central server, the one or more on-premises devices or a combination thereof.

In performing the one or more operations for monitoring the health conditions of the one or more animals based on the generated command, the operation performing module 220 retrieves the one or more location parameters from the storage unit 206. In an exemplary embodiment of the present disclosure, the one or more location parameters include one or more predefined locations, current location of the set of most optimal mobile servers and the like. In an exemplary embodiment of the present disclosure, the one or more predefined locations include location of base station, one or more nearest regions with internet connectivity or on-premises location. Further, the operation performing module 220 determines the one or more distance parameters based on the retrieved one or more location parameters by using the data management-based AI model. In an exemplary embodiment of the present disclosure, the one or more distance parameters include distance between the set of most optimal mobile servers and the one or more predefined locations, optimal route between the set of most optimal mobile servers and the one or more predefined locations and the like. The operation performing module 220 navigates the set of most optimal mobile servers from the location of the ROI to the one or more predefined locations based on the retrieved one or more location parameters and the determined one or more distance parameters. Furthermore, the operation performing module 220 uploads the multimedia data to the central server 110, the one or more on-premises devices or a combination thereof from the one or more predefined locations by using the set of most optimal mobile servers upon navigating the set of most optimal mobile servers to the one or more predefined locations. In an embodiment of the present disclosure, the set of most optimal mobile servers may categorize the multimedia data including the plurality of images and the plurality of videos in accordance with image capturing device, such that the multimedia data may be stored with a nomenclature similar to the one or more image capturing devices 102. For example, the nomenclature may be name_location_image number_date/time stamp.

The health management module 222 receives the plurality of images, the plurality of videos or a combination thereof from the set of most optimal servers. In another embodiment of the present disclosure, the plurality of images, the plurality of videos or a combination thereof are received from the central server 110, the one or more on-premises devices or a combination thereof. The one or more plurality of images and the plurality of videos are associated with a set of animals. In an exemplary embodiment of the present disclosure, the set of animals include wildlife, livestock, domesticated animals or any combination thereof. In an exemplary embodiment of the present disclosure, the set of animals include cow, cat, dog, horse and the like. Further, the health management module 222 identifies one or more characteristics in the received plurality of images, the received plurality of videos or a combination thereof by using the data management-based AI model. In an embodiment of the present disclosure, the data management-based AI model is a Machine Learning (ML) model, an AI model or a combination thereof. In an exemplary embodiment of the present disclosure, the one or more characteristics include one or more eyes, one or more retinas, one or more muzzles, one or more ears and the like. In an embodiment of the present disclosure, a retina scanner may be used to take images of eye retinas of the set of animals for detection of disease. The health management module 222 extracts one or more features from the identified one or more characteristics of the set of animals by using the data management-based AI model. In an exemplary embodiment of the present disclosure, the one or more characteristics include one or more eyes features, one or more retinas features, one or more muzzles features, one or more ears features and the like. Furthermore, the health management module 222 determines one or more changes in the extracted one or more features associated with the set of animals by comparing the extracted one or more features with prestored features corresponding to the set of animals by using the data management-based AI model. The health management module 222 detects a presence or absence of one or more diseases in the set of animals based on the determined one or more changes and predefined disease information by using the data management-based AI model. Further, the health management module 222 may also predict a likelihood of the one or more diseases, one or more changes or a combination thereof in the set of animals based on the determined one or more changes and the predefined disease information by using the data management-based AI model. The health management module 222 may also determine how healthy are each of the set of animals based on the determined one or more changes and the predefined disease information by using the data management-based AI model. In an embodiment of the present disclosure, the detected presence or absence of one or more diseases and the predicted likelihood are outputted on user interface screen of the one or more user devices. In an exemplary embodiment of the present disclosure, the one or more user devices may include a laptop computer, desktop computer, tablet computer, smartphone, wearable device, smart watch, a digital camera and the like. In an embodiment of the present disclosure, an image source is added inside and outside of body. For example, image source outside the body includes glasses, camera, XR glasses and the like. The image source inside the body is worn inside the body, such as contact lens configured to take pictures, analyze the image or a combination thereof. Further, animal prints of muzzle or hoofs or any other body part of an animal that could be pressed onto a paper and print made then scanned by copier/scanner or picture taken. Furthermore, nose printing is used to obtain prints to make sure an animal has not been showed more than once in certain competitions. In an embodiment of the present disclosure, an infrared scanner is used for infrared scanning to scan an image of animal, such as a barcode at a grocery store. The health management module is also configured to detect pregnancy status in the set of animals based on the determined one or more changes, and predefined pregnancy information by using the data management-based AI model. Furthermore, the health management module 222 monitors the pregnancy status in the set of animals based on the determined one or more changes, and the predefined pregnancy information by using the data management-based AI model. The health management module 222 determines scale of optimization associated with the set of animals based on the determined one or more changes, muzzle, beads and ridges of the set of animals by using the data management-based AI model. The health management module 222 detects dehydration in the set of animals based on one or more dehydration parameters and the determined one or more changes by using the data management-based AI model. In an exemplary embodiment of the present disclosure, the one or more dehydration parameters include sunken eyes, drooping skin on face, crusted muzzle, and the like. Further, the health management module 222 determines nutritional stress in the set of animals based on one or more stress parameters and the determined one or more changes by using the data management-based AI model. In an exemplary embodiment of the present disclosure, the one or more stress parameters include slimming, elongated face, elongated head and the like. The health management module 222 determines estrous in the set of animals based on one or more estrous parameters and the determined one or more changes by using the data management-based AI model. In an exemplary embodiment of the present disclosure, the one or more estrous parameters include flared nostrils, possible glazed eyes, wrinkled nose skin and the like.

In an embodiment of the present disclosure, the one or more proximal mobile servers 108 include the plurality of modules 112, a processing unit, a connection port, a wired connection port, one or more cameras, an operating arm, a memory chip, the storage pouch and a set of wheels. The processing unit may be a Central Processing Unit (CPU), Graphics Processing Unit (GPU), a Tensor Processing Unit (TPU) or any combination thereof working together or separately. Further, the processing unit processes information, such as determining if the images are to be downloaded or if the memory card is required to be put in the storage pouch and replaced with another memory card. The processing unit also facilitates in processing and uploading of the multimedia data to the central server 110, processing of the multimedia data at the base station at the ranch or a combination thereof to determine health status of the set of animals. The processing unit also provides status of each of the one or more image capturing devices 102 i.e., functional, and non-functional. The connection port facilitates in wireless connectivity with the one or more image capturing devices 102. Further, the wired connection port is where the cable, such as USB or HDMI resides. The one or more cameras show the set of real-time images and the set of real-time videos in real time to the user and record how the one or more proximal mobile servers 108 are connecting to the one or more image capturing devices 102 installed on premise. If an operator is using the one or more cameras to move or control the one or more proximal mobile servers 108, the operator may view real-time images and the set of real-time videos at any time either by logging in the web application, the mobile application or on a dashboard. In an embodiment of the present disclosure, when the wired connection port is used, the operating arm takes the cable to connect it with the one or more image capturing devices 102. Furthermore, the memory card from the one or more image capturing devices 102 are stored in the storage pouch. In an embodiment of the present disclosure, the storage pouch may be two i.e., a first storage pouch and a second storage pouch. The first storage pouch is for used memory cards and second storage pouch is for new memory cards that needs to be plugged in the one or more image capturing devices 102. In another embodiment of the present disclosure, the storage pouch may be one divided in two storage pouches. When using the storage pouch, the operating arm is required to remove the used memory cards from the one or more image capturing devices 102 and to put the new memory cards inside the one or more image capturing devices 102. Further, the set of wheels are required for the one or more proximal mobile servers 108 to move around. The one or more proximal mobile servers 108 may also be installed on something moveable, such as a vehicle or an animals to facilitate movement. Furthermore, the one or more proximal mobile servers 108 may also include a set of wings to fly. In an embodiment of the present disclosure, the one or more proximal mobile servers 108 may collect the multimedia data sequentially or in random order with a log, such that the user may be notified if any image capturing device is missing. The one or more proximal mobile servers 108 include a set of sensors. For example, the set of sensors are like proximity sensors on a self-driving car, or self-parking car. The set of sensors may bounce off nearby objects to determine distance. In an embodiment of the present disclosure, the set of sensors of the one or more proximal mobile sensors act as a scanner for a 3D printer and creates a replica image of muzzle of the set of animals, such that the created replica image may be used for determination of disease. In an embodiment of the present disclosure, this is achieved by using various cameras installed at the ROI to take pictures of a cow and its face 360 degrees and create a hologram of the cow for the determination of health. For example, even as simple as setting up cow's facial recognition on phone similar to what is there for human when phone is set-up, various lines are filled in for the phone to recognize the owner at any angle.

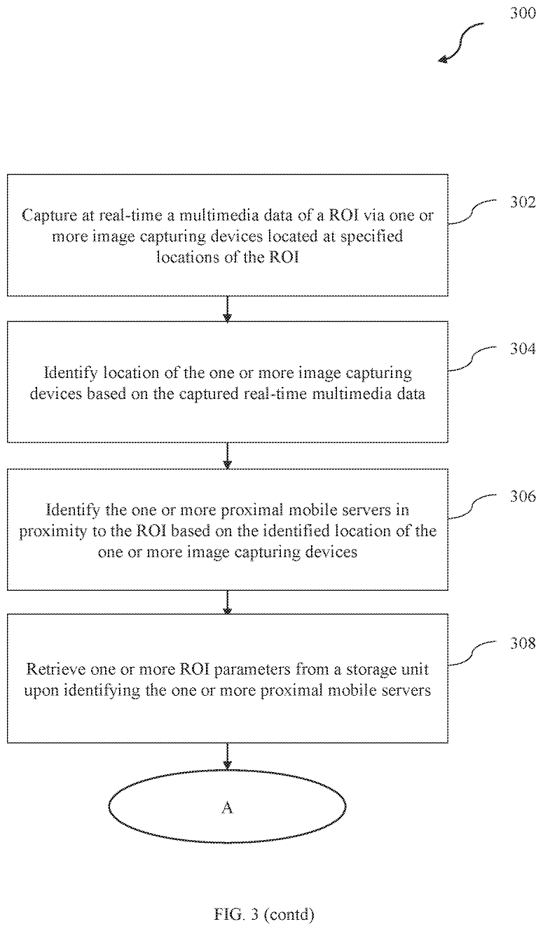

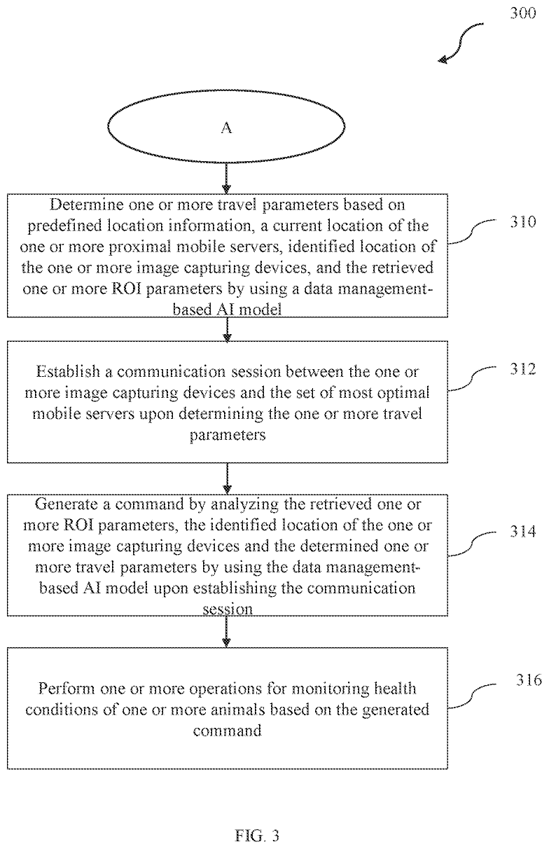

FIG. 3 is a process flow diagram illustrating an exemplary AI-based method for monitoring health conditions, in accordance with an embodiment of the present disclosure. At step 302, multimedia data of ROI is captured at real-time via one or more image capturing devices 102 located at specified locations of the ROI. In an embodiment of the present disclosure, the multimedia data is indicative of health of one or more animals. The ROI includes one or more locations at which the one or more animals are placed. In an exemplary embodiment of the present disclosure, the one or more animals include cow, cat, dog, horse and the like. In an embodiment of the present disclosure, the one or more image capturing devices 102 are configured to capture the multi-media data from one or more proximal mobile servers 108 upon navigating one or more optimal mobile servers to location of the RO. The one or more image capturing devices 102 may include a set of cameras to capture multimedia data corresponding to ROI. In an exemplary embodiment of the present disclosure, the set of cameras include a stationary camera, a movable or mobile camera or a combination thereof. For example, the one or more image capturing devices 102 may include optical cameras, thermos cameras, VR cameras, 3D cameras, or any combination thereof or any other imaging source. In an embodiment of the present disclosure, the one or more image capturing devices 102 are connection ready, such as Wi-Fi or Bluetooth enabled, either built in or connecting to other device that makes them connection ready. In an exemplary embodiment of the present disclosure, the ROI may be one or more farm areas. In an exemplary embodiment of the present disclosure, the multimedia data may include a plurality of images and a plurality of videos corresponding to the ROI. The plurality of images and the plurality of videos may be of cattle in the one or more farm areas. In an exemplary embodiment of the present disclosure, the one or more image capturing devices 102 are located at a water pond, next to the water pond, submerged in the water pond, a feeder truck, trailer, pathway to the trailer, loading ramp, unloading ramp, walkway to milking parlor, one or more milking booths, a parlor's railings, a standalone object, body of cattle, an animal, chute, a walkway to the chute, a pen, a vehicle, a user or any combination thereof. The one or more image capturing devices 102 are installed in the pen either permanently or temporarily to capture the multimedia data. The pen may be indoors and outdoors. In an exemplary embodiment of the present disclosure, the vehicle may be jeeps, tractors, ATV and the like. The animal may be cattle, horse, dog and the like. For example, the user may be a rancher. In an embodiment of the present disclosure, the one or more image capturing devices 102 are customized, off-the shelf or a combination thereof. In an embodiment of the present disclosure, the feeder truck include feedlot, backgrounders feeder truck and the like used for feeding the cattle.

At step 304, location of the one or more image capturing devices 102 is identified based on the captured real-time multimedia data.

At step 306, one or more proximal mobile servers 108 in proximity to the ROI are identified based on the identified location of the one or more image capturing devices. For example, the one or more proximal mobile servers 108 include one or more drones, one or more water-surface robots, one or more land robots, one or more under-water robots or a combination thereof. In an embodiment of the present disclosure, the one or more proximal mobile servers 108 are self-driven.

At step 308, one or more ROI parameters are retrieved from a storage unit 206 upon identifying the one or more proximal mobile servers 108. In an exemplary embodiment of the present disclosure, the one or more ROI parameters include a location of the ROI, one or more images of the one or more image capturing devices 102, type of the identified one or more proximal mobile servers 108, layout of the ROI and the like. In an embodiment of the present disclosure, a current location of the identified one or more proximal mobile servers 108 may be identified by using one or more GPSs. In an embodiment of the present disclosure, the one or more images of the one or more image capturing devices 102 are retrieved to identify the one or more image capturing devices 102 at the ROI.

At step 310, one or more travel parameters are determined based on predefined location information, the current location of the one or more proximal mobile servers 108, the identified location of the one or more image capturing devices 102 and the retrieved one or more ROI parameters by using a data management-based AI model. In an exemplary embodiment of the present disclosure, the one or more travel parameters include distance between the identified one or more proximal mobile servers 108 and the ROI, optimal path, a set of most optimal mobile servers from the identified one or more proximal mobile servers 108 to reach the ROI and the like.

At step 312, a communication session is established between the one or more image capturing devices 102 and the set of most optimal mobile servers upon determining the one or more travel parameters.

At step 314, a command is generated by analyzing the retrieved one or more ROI parameters, the identified location of the one or more image capturing devices 102 and the determined one or more travel parameters by using the data management-based AI model. The generated command is transferred to the set of most optimal mobile servers for performing one or more operation

At step 316, one or more operations are performed for monitoring health conditions of the one or more animals based on the generated command. In performing the one or more operations for monitoring the health conditions of the one or more animals based on the generated command, the AI-based method 300 includes navigating the set of most optimal mobile servers from the current location of the set of most optimal mobile servers to the location of the one or more image capturing devices 102 based on the generated command. Further, the AI-based method 300 includes transferring the multimedia data from the one or more image capturing devices 102 to a central server 110, one or more on-premises devices or a combination thereof based on the generated command. In an exemplary embodiment of the present disclosure, the multimedia data includes the plurality of images and the plurality of videos corresponding to the ROI. Further, the AI-based method 300 includes retrieving the multimedia data from the one or more image capturing devices 102 via the set of optimal mobile servers by using one or more wired means, one or more wireless means or a combination thereof upon navigating the set of most optimal mobile servers to the one or more image capturing devices. The AI-based method 300 includes uploading the retrieved multimedia data to the central server 110, the one or more on-premises devices or a combination thereof via the set of most optimal mobile servers.

In an embodiment of the present disclosure, the AI-based method 300 includes receiving a set of real-time images and a set of real-time videos corresponding to the one or more image capturing devices 102 from the set of most optimal mobile servers upon navigating the set of most optimal mobile servers to the location of the ROI. Further, the AI-based method 300 includes detecting an exact location of the one or more image capturing devices 102 in the ROI based on the received set of real-time images, the received set of real-time videos, the retrieved one or more ROI parameters, a set of predefined location coordinates of the one or more image capturing devices 102 and the determined one or more travel parameters by using the data management-based AI model.

Further, in uploading the multimedia data from the one or more image capturing devices 102 located in the ROI to the central server 110, one or more on-premises devices or a combination thereof upon navigating the set of most optimal mobile servers to the location of the ROI, the AI-based method 300 includes retrieving the multimedia data from the one or more image capturing devices 102 via the set of optimal mobile servers by using one or more wired means and one or more wireless means upon detecting the exact location of the one or more image capturing devices 102. In an exemplary embodiment of the present disclosure, the one or more wireless means include cellular means, Wi-Fi, Bluetooth, LORAN or a combination thereof. In an exemplary embodiment of the present disclosure, the one or more wired means include USB, HDMI, cable, a memory card and the like. In an embodiment of the present disclosure, the multimedia data is retrieved at a regular interval, such as twice, thrice a day or every few hours. Further, the AI-based method 300 includes uploading the retrieved multimedia data to the central server 110, the one or more on-premises devices or a combination thereof via the set of most optimal mobile servers. In an embodiment of the present disclosure, the set of most optimal mobile servers may take the memory card out of the one or more image capturing devices 102 and install within itself to download multimedia data, deposit the memory card in its storage pouch and install a new memory card to be used by the one or more image capturing devices 102 or a combination thereof. The one or more optimal mobile servers may come back with memory cards in the storage pouch and the downloaded multimedia data is sent to the central server 110 for processing. In another example, the one or more proximal mobile servers 108 corresponds to a wearable device attached to the cow. Since the cow moves to multiple locations where the one or more image capturing devices 102 are installed, the wearable device may act as a mobile server and retrieve the multimedia data wirelessly. The one or more image capturing devices 102 may also be in the form of a wearable device, which may be worn by the user. In an embodiment of the present disclosure, the wearable device may be XR device. The user wears the wearable device and walk around in the ranch and the wearable device captures images and videos to analyse the captured images and videos for health and well-being purposes.

In an embodiment of the present disclosure, the one or more image capturing devices 102 are also configured to capture at real-time the multimedia data of the ROI. Further, the one or more image capturing devices 102 uploads the retrieved multimedia data to the central server, the one or more on-premises devices or a combination thereof.

Furthermore, in performing the one or more operations for monitoring the health conditions of the one or more animals based on the generated command, the AI-based method 300 includes retrieving the one or more location parameters from the storage unit 206. In an exemplary embodiment of the present disclosure, the one or more location parameters include one or more predefined locations, current location of the set of most optimal mobile servers and the like. In an exemplary embodiment of the present disclosure, the one or more predefined locations include location of base station, one or more nearest regions with internet connectivity or on-premises location. Further, the AI-based method 300 includes determining the one or more distance parameters based on the retrieved one or more location parameters by using the data management-based AI model. In an exemplary embodiment of the present disclosure, the one or more distance parameters include distance between the set of most optimal mobile servers and the one or more predefined locations, optimal route between the set of most optimal mobile servers and the one or more predefined locations and the like. The AI-based method 300 includes navigating the set of most optimal mobile servers from the location of the ROI to the one or more predefined locations based on the retrieved one or more location parameters and the determined one or more distance parameters. Furthermore, the AI-based method 300 includes uploading the multimedia data to the central server 110, the one or more on-premises devices or a combination thereof from the one or more predefined locations by using the set of most optimal mobile servers upon navigating the set of most optimal mobile servers to the one or more predefined locations. In an embodiment of the present disclosure, the set of most optimal mobile servers may categorize the multimedia data including the plurality of images and the plurality of videos in accordance with image capturing device, such that the multimedia data may be stored with a nomenclature similar to the one or more image capturing devices 102. For example, the nomenclature may be name_location_image number_date/time stamp.

In an embodiment of the present disclosure, the AI-based method 300 includes receiving the plurality of images, the plurality of videos or a combination thereof from the set of most optimal servers. In another embodiment of the present disclosure, the plurality of images, the plurality of videos or a combination thereof are received from the central server 110, the one or more on-premises devices or a combination thereof. The one or more plurality of images and the plurality of videos are associated with a set of animals. In an exemplary embodiment of the present disclosure, the set of animals include wildlife, livestock, domesticated animals or any combination thereof. In an exemplary embodiment of the present disclosure, the set of animals include cow, cat, dog, horse and the like. Further, the AI-based method 300 includes identifying one or more characteristics of the set of animals in the received plurality of images, the received plurality of videos or a combination thereof by using the data management-based AI model. In an embodiment of the present disclosure, the data management-based AI model is a ML model, an AI model or a combination thereof. In an exemplary embodiment of the present disclosure, the one or more characteristics include one or more eyes, one or more retinas, one or more muzzles, one or more ears and the like. In an embodiment of the present disclosure, a retina scanner may be used to take images of eye retinas of the set of animals for detection of disease. The AI-based method 300 includes extracting one or more features from the identified one or more characteristics of the set of animals by using the data management-based AI model. In an exemplary embodiment of the present disclosure, the one or more characteristics include one or more eyes features, one or more retinas features, one or more muzzles features, one or more ears features and the like. Furthermore, the AI-based method 300 includes determining one or more changes in the extracted one or more features associated with the set of animals by comparing the extracted one or more features with prestored eye features corresponding to the set of animals by using the data management-based AI model. The AI-based method 300 includes detecting a presence or absence of one or more diseases in the set of animals based on the determined one or more changes and predefined disease information by using the data management-based AI model. Further, the AI-based method 300 includes predicting a likelihood of the one or more diseases, one or more changes or a combination thereof in the set of animals based on the determined one or more changes and the predefined disease information by using the data management-based AI model. The AI-based method 300 may also include determining how healthy are each of the set of animals based on the determined one or more changes and the predefined disease information by using the data management-based AI model. In an embodiment of the present disclosure, the detected presence or absence of one or more diseases and the predicted likelihood are outputted on user interface screen of the one or more user devices. In an exemplary embodiment of the present disclosure, the one or more user devices may include a laptop computer, desktop computer, tablet computer, smartphone, wearable device, smart watch, a digital camera and the like. Furthermore, nose printing is used to obtain prints to make sure an animal has not been showed more than once in certain competitions. In an embodiment of the present disclosure, an infrared scanner is used for infrared scanning to scan an image of animal, such as a barcode at a grocery store. The AI-based method 300 includes detecting pregnancy status in the set of animals based on the determined one or more changes, and predefined pregnancy information by using the data management-based AI model. Furthermore, the AI-based method 300 includes monitoring the pregnancy status in the set of animals based on the determined one or more changes, and the predefined pregnancy information by using the data management-based AI model. The AI-based method 300 includes determining scale of optimization associated with the set of animals based on the determined one or more changes, muzzle, beads and ridges of the set of animals by using the data management-based AI model. The AI-based method 300 includes detecting dehydration in the set of animals based on one or more dehydration parameters and the determined one or more changes by using the data management-based AI model. In an exemplary embodiment of the present disclosure, the one or more dehydration parameters include sunken eyes, drooping skin on face, crusted muzzle, and the like. Further, the AI-based method 300 includes determining nutritional stress in the set of animals based on one or more stress parameters and the determined one or more changes by using the data management-based AI model. In an exemplary embodiment of the present disclosure, the one or more stress parameters include slimming, elongated face, elongated head and the like. The AI-based method 300 includes determining estrous in the set of animals based on one or more estrous parameters and the determined one or more changes by using the data management-based AI model. In an exemplary embodiment of the present disclosure, the one or more estrous parameters include flared nostrils, possible glazed eyes, wrinkled nose skin and the like.

The AI-based method 300 may be implemented in any suitable hardware, software, firmware, or combination thereof.

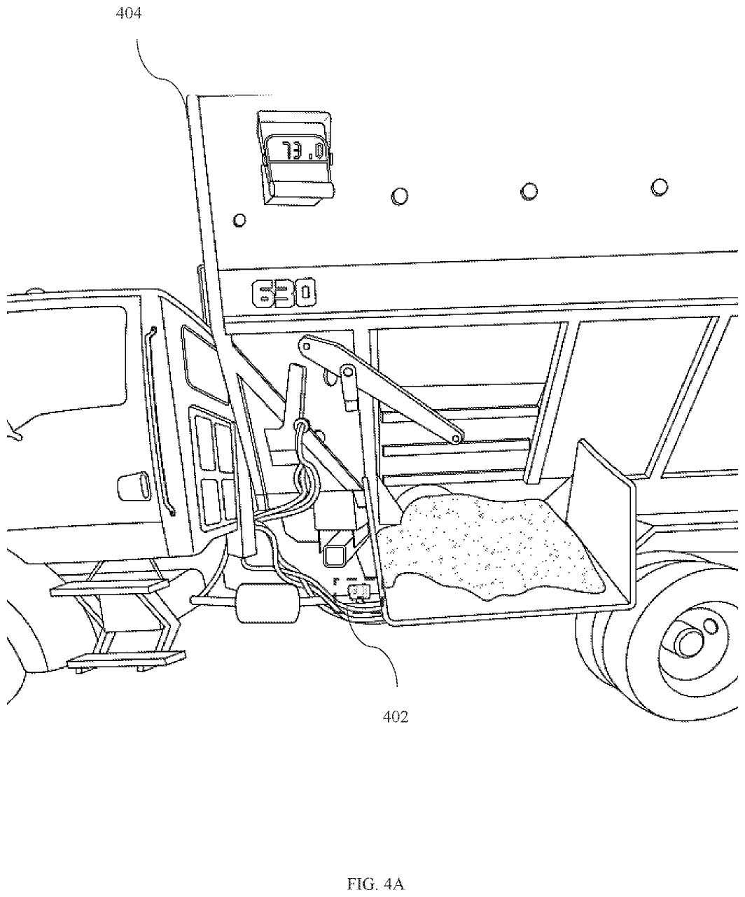

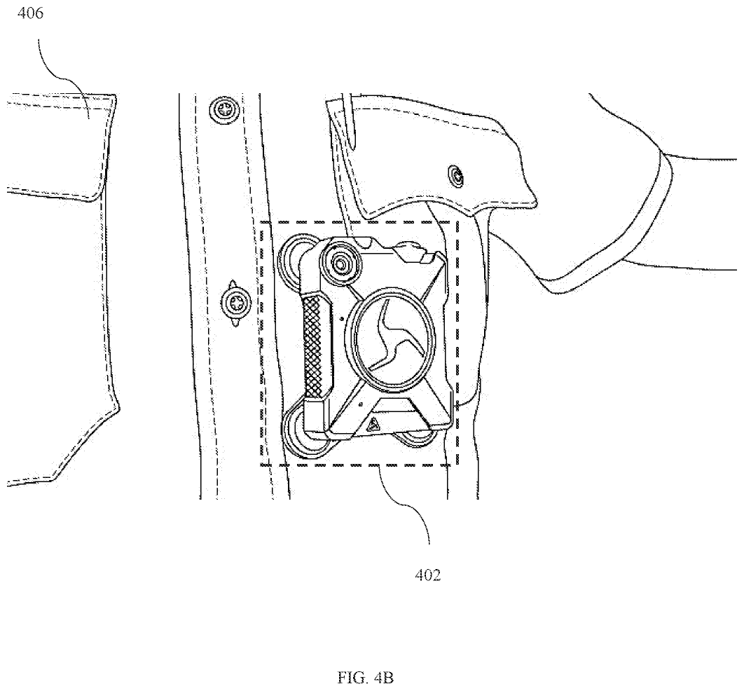

FIGS. 4A-4B are pictorial depiction illustrating location of image capturing devices, in accordance with an embodiment of the present disclosure. FIG. 4A displays location of an image capturing device 402 on a feeder truck 404. FIG. 4B displays location of the image capturing device 402 worn by the rancher 406.

Thus, various embodiments of the present AI-based computing system 104 provide a solution to retrieve data from image capturing devices. The AI-based computing system 104 discloses the one or more proximal mobile servers 108 which connect to the one or more image capturing devices 102 on a regular basis and downloads the multimedia data using either wireless or wired methods and then go to a Wi-Fi or internet connectivity to upload the multimedia data to be processed. The one or more proximal mobile servers 108 may travel on the water surface, under water surface, on air, on land or a combination thereof to achieve its goal to retrieve the multimedia data on a regular interval as required and then move to a home location or another place where the retrieved multimedia data may be uploaded to the central server 110 to be processed on the cloud or in case of on premise solution, transfer the retrieved multimedia data to the one or more on-premises devices. Further, the one or more proximal mobile servers 108 may be robots, drones, or any other devices that can travel on their own. The one or more proximal mobile servers 108 may also be attached to a person or a thing and as that person or that thing goes around a ranch, the multimedia data may be uploaded to the one or more mobile servers. Furthermore, the one or more proximal mobile servers 108 may be collection devices as well. The one or more proximal mobile servers 108 may be flown like a drone, programmed to go from one place to another place much like a robot or a combination thereof. Further, the one or more proximal mobile servers 108 may collect the data sequentially or in random order with the log, such that the user may be notified if any image capturing device is missing. In an embodiment of the present disclosure, when network connectivity i.e., cellular network or Wireless Fidelity (Wi-Fi), is not available, the one or more proximal mobile servers 108 may retrieve the multimedia data and then move to a home location or another place where the retrieved multimedia data may be uploaded to the central server 110 or transfer the retrieved multimedia data to the one or more on-premises devices. Further, when the internet connectivity is available, the one or more image capturing devices 102 may directly upload the multimedia data to the central server, the one or more on-premises devices or a combination thereof.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. An Artificial intelligence (AI)-based computing system for monitoring health conditions, the AI-based computing system comprising:
one or more hardware processors; and
a memory coupled to the one or more hardware processors, wherein the memory comprises a plurality of modules in the form of programmable instructions executable by the one or more hardware processors, and wherein the plurality of modules comprises:
a data capturing module configured to capture at real-time a multimedia data of a Region of Interest (ROI) via one or more image capturing devices located at specified locations of the ROI, wherein the multimedia data is indicative of health of one or more animals, wherein the ROI comprises one or more locations at which the one or more animals are placed, wherein the one or more image capturing devices are configured to capture the multi-media data from one or more proximal mobile servers upon navigating the one or more optimal mobile servers to location of the ROI, and wherein the one or more image capturing devices are located at: least one of a water pond, next to the water pond, submerged in the water pond, a feeder truck, trailer, pathway to the trailer, loading ramp, unloading ramp, walkway to milking parlor, a milking booth, a parlor's railings, a standalone object, body of cattle, an animal, chute, a walkway to the chute, a pen, a vehicle, and a user;
a location identification module configured to identify location of the one or more image capturing devices based on the captured real-time multimedia data;
a server identification module configured to identify the one or more proximal mobile servers in proximity to the ROI based on the identified location of the one or more image capturing devices;
a parameter retrieval module configured to retrieve one or more ROI parameters from a storage unit upon identifying the one or more proximal mobile servers, wherein the one or more ROI parameters comprises: a location of the ROI, one or more images of the one or more image capturing devices, type of the identified one or more proximal mobile servers, and layout of the ROI;
a parameter determination module configured to determine one or more travel parameters based on predefined location information, a current location of the one or more proximal mobile servers, identified location of the one or more image capturing devices, and the retrieved one or more ROI parameters by using a data management-based AI model, wherein the one or more travel parameters comprises: a distance between the identified one or more proximal mobile servers and the ROI, optimal path and a set of most optimal mobile servers from the identified one or more proximal mobile servers to reach the ROI;
a session establishing module configured to establish a communication session between the one or more image capturing devices and the set of most optimal mobile servers upon determining the one or more travel parameters;
a command generation module configured to generate a command by analyzing the retrieved one or more ROI parameters, the identified location of the one or more image capturing devices and the determined one or more travel parameters by using the data management-based AI model upon establishing the communication session, wherein the generated command is transferred to the set of most optimal mobile servers for performing one or more operations; and
an operation performing module configured to perform the one or more operations for monitoring health conditions of the one or more animals based on the generated command.

2. The AI-based computing system of claim 1, wherein in performing the one or more operations for monitoring the health conditions of the one or more animals based on the generated command, the operation performing module is configured to:
navigate the set of most optimal mobile servers from the current location of the set of most optimal mobile servers to the location of the one or more image capturing devices based on the generated command:
transfer the multimedia data from the one or more image capturing devices to at least one of a central server and one or more on-premises devices based on the generated command, wherein the multimedia data comprises a plurality of images and a plurality of videos corresponding to the ROI;
retrieve the multimedia data from the one or more image capturing devices via the set of optimal mobile servers by using at least one of: one or more wired means and one or more wireless means upon navigating the set of most optimal mobile servers to the one or more image capturing devices; and
upload the retrieved multimedia data to at least one of: the central server and the one or more on-premises devices via the set of most optimal mobile servers.

3. The AI-based computing system of claim 1, wherein the one or more image capturing devices are configured to:
capture at real-time the multimedia data of the ROI; and
upload the retrieved multimedia data to at least one of: the central server and the one or more on-premises devices.

4. The AI-based computing system of claim 1, wherein in performing the one or more operations for monitoring the health conditions of the one or more animals based on the generated command, the operation performing module is configured to:
retrieve one or more location parameters from the storage unit, wherein the one or more location parameters comprises: one or more predefined locations and current location of the set of most optimal mobile servers, and wherein the one or more predefined locations comprises: location of one of: base station, one or more nearest regions with internet connectivity and on-premises location;
determine one or more distance parameters based on the retrieved one or more location parameters by using the data management-based AI model, wherein the one or more distance parameters comprises: distance between the set of most optimal mobile servers and the one or more predefined locations and optimal route between the set of most optimal mobile servers and the one or more predefined locations;
navigate the set of most optimal mobile servers from the location of the ROI to the one or more predefined locations based on the retrieved one or more location parameters and the determined one or more distance parameters; and
upload the multimedia data at least one of the central server and the one or more on-premises devices from the one or more predefined locations by using the set of most optimal mobile servers upon navigating the set of most optimal mobile servers to the one or more predefined locations.

5. The AI-based computing system of claim 1, Wherein the one or more mobile servers comprises at least one of one or more drones, one or more water-surface robots, one or more land robots, and one or more under-water robots.

6. The AI-based computing system of claim 1, wherein the one or more image capturing cameras comprises at least one of a stationary camera and a movable camera.

7. The AI-based computing system of claim 2, wherein the one or more wireless means comprises at least one of a cellular means, Wireless Fidelity (Wi-Fi), Bluetooth, and Long-Range Navigation (LORAN).

8. The AI-based computing system of claim 2, wherein the one or more wired means comprises Universal Serial Bus (USB), High-Definition Multimedia Interface (HDMI), cable, and a memory card.

9. The AI based computing system of claim 1, further comprising a health management module configured to:
receive at least one of a plurality of images and a plurality of videos from the set of most optimal servers, wherein the one or more plurality of images and the plurality of videos are associated with a set of animals, and wherein the set of animals comprises at least of: wildlife, livestock and domesticated animals;
identify one or more characteristics of the set of animals in the received at least one of the plurality of images and the plurality of videos by using the data management-based AI model, wherein the data management-based AI model is at least one of a Machine Learning (ML) model and an AI model, and wherein the one or more characteristics comprise one or more eyes, one or more retinas, one or more muzzles and one or more ears;
extract one or more features from the identified one or more characteristics of the set of animals by using the data management-based AI model, wherein the one or more characteristics comprise one or more eyes features, one or more retinas features, one or more muzzles features and one or more ears features;
determine one or more changes in the extracted one or more features associated with the set of animals by comparing the extracted one or more features with prestored features corresponding to the set of animals by using the data management-based AI model;
perform at least one of:
detecting one of a presence and absence of one or more diseases in the set of animals based on the determined one or more changes, and predefined disease information by using the data management-based AI model; and
predicting a likelihood of at least one of: the one or more diseases and one or more health changes in the set of animals based on the determined one or more changes, and the predefined disease information by using the data management-based AI model; and
perform at least one of:
detecting pregnancy status in the set of animals based on the determined one or more changes, and predefined pregnancy information by using the data management-based AI model;
monitoring the pregnancy status in the set of animals based on the determined one or more changes, and the predefined pregnancy information by using the data management-based AI model;
determining scale of optimization associated with the set of animals based on the determined one or more changes, muzzle, beads and ridges of the set of animals by using the data management-based AI model;
detecting dehydration in the set of animals based on one or more dehydration parameters and the determined one or more changes by using the data management-based AI model, wherein the one or more dehydration parameters comprise sunken eyes, drooping skin on face and crusted muzzle;
determining nutritional stress in the set of animals based on one or more stress parameters and the determined one or more changes by using the data management-based AI model, wherein the one or more stress parameters comprise slimming, elongated face and elongated head; and
determining estrous in the set of animals based on one or more estrous parameters and the determined one or more changes by using the data management-based AI model, wherein the one or more estrous parameters comprise flared nostrils, possible glazed eyes and wrinkled nose skin.

10. An AI-based method for monitoring health conditions, the AI-based method comprising:
capturing, by one or more hardware processors, at real-time a multimedia data of a Region of Interest (ROI) via one or more image capturing devices located at specified locations of the ROI, wherein the multimedia data is indicative of health of one or more animals, wherein the ROI comprises one or more locations at which the one or more animals are placed, wherein the one or more image capturing devices are configured to capture the multi-media data from one or more proximal mobile servers upon navigating the one or more optimal mobile servers to location of the ROI, and wherein the one or more image capturing devices are located at: at least one of a water pond, next to the water pond, submerged in the water pond, a feeder truck, trailer, pathway to the trailer, loading ramp, unloading ramp, walkway to milking parlor, one or more milking booths, a parlor's railings, a standalone object, body of cattle, one or more animals, chute, a walkway to the chute, a pen, a vehicle and a user;
identifying, by the one or more hardware processors, location of the one or more image capturing devices based on the captured real-time multimedia data;
identifying, by the one or more hardware processors, the one or more proximal mobile servers in proximity to the ROI based on the identified location of the one or more image capturing devices;
retrieving, by the one or more hardware processors, one or more ROI parameters from a storage unit upon identifying the one or more proximal mobile servers, wherein the one or more ROI parameters comprises a location of the ROI, one or more images of the one or more image capturing devices, type of the identified one or more proximal mobile servers, and layout of the ROI;
determining, by the one or more hardware processors, one or more travel parameters based on predefined location information, a current location of the one or more proximal mobile servers, identified location of the one or more image capturing devices, and the retrieved one or more ROI parameters by using a data management-based AI model, wherein the one or more travel parameters comprises a distance between the identified one or more proximal mobile servers and the ROI, optimal path and a set of most optimal mobile servers from the identified one or more proximal mobile servers to reach the ROI;
establishing, by the one or more hardware processors, a communication session between the one or more image capturing devices and the set of most optimal mobile servers upon determining the one or more travel parameters;
generating, by the one or more hardware processors, a command by analyzing the retrieved one or more ROI parameters, the identified location of the one or more image capturing devices and the determined one or more travel parameters by using the data management-based AI model upon establishing the communication session, wherein the generated command is transferred to the set of most optimal mobile servers for performing one or more operations; and
performing, by the one or more hardware processors, the one or more operations for monitoring health conditions of the one or more animals based on the generated command.

11. The AI-based method of claim 10, wherein performing the one or more operations for monitoring the health conditions of the one or more animals based on the generated command comprises:
navigating the set of most optimal mobile servers from the current location of the set of most optimal mobile servers to the location of the one or more image capturing devices based on the generated command;
transferring the multimedia data from the one or more image capturing devices to at least one of a central server and one or more on-premises devices based on the generated command, wherein the multimedia data comprises a plurality of images and a plurality of videos corresponding to the ROI;
retrieving the multimedia data from the one or more image capturing devices via the set of optimal mobile servers by using at least one of: one or more wired means and one or more wireless means upon navigating the set of most optimal mobile servers to the one or more image capturing devices; and
uploading the retrieved multimedia data to at least one of the central server and the one or more on-premises devices via the set of most optimal mobile servers.

12. The AI-based method of claim 10, wherein the one or more image capturing devices are configured to
capturing at real-time the multimedia ta of the ROI; and
uploading the retrieved multimedia data to at least one of: the central server and the one or more on-premises devices.

13. The AI-based method of claim 10, wherein performing the one or more operations for monitoring the health conditions of the one or more animals based on the generated command comprises:
retrieving one or more location parameters from the storage unit, wherein the one or more location parameters comprises: one or more predefined locations and current location of the set of most optimal mobile servers, and wherein the one or more predefined locations comprises: location of one of: base station, one or more nearest regions with internet connectivity and on-premises location;
determining one or more distance parameters based on the retrieved one or more location parameters by using the data management-based AI model, wherein the one or more distance parameters comprises: distance between the set of most optimal mobile servers and the one or more predefined locations and optimal route between the set of most optimal mobile servers and the one or more predefined locations;
navigating the set of most optimal mobile servers from the location of the ROI to the one or more predefined locations based on the retrieved one or more location parameters and the determined one or more distance parameters; and
uploading the multimedia data to at least one of: the central server and the one or more on-premises devices from the one or more predefined locations by using the set of most optimal mobile servers upon navigating the set of most optimal mobile servers to the one or more predefined locations.

14. The AI-based method of claim 10, wherein the one or more mobile servers comprises at least one of one or more drones, one or more water-surface robots, one or more land robots and one or more wider-water robots.

15. The AI-based method of claim 10, wherein the one or more image capturing cameras comprises at least one of a stationary camera and a movable camera.

16. The AL-based method of claim 11, wherein the one or more wireless means comprises at least one of: cellular means, Bluetooth and LORAN, and wherein the one or more wired means comprises: USB, HDMI cable and a memory card.

17. The AI based method of claim 10, further comprising:
receiving at least one of a plurality of images and a plurality of videos from the set of most optimal servers, wherein the one or more plurality of images and the plurality of videos are associated with set of animals, and wherein the set of animals comprises at least one of: wildlife, livestock and domesticated animals;
identifying one or more characteristics of the set of animals in the received at least one of: the plurality of images and the plurality of videos by using the data management-based AI model, wherein the data management-based AI model is at least one of a ML model and an AI model, and wherein the one or more characteristics comprise one or more eyes, one or more retinas, one or more muzzles and one or more ears;
extracting one or more features from the identified one or more characteristics of the set of animals by using the data management-based AI model, wherein the one or more characteristics comprise one or more eyes features, one or more retinas features, one or more muzzles features and one or more ears features;
determining one or more changes in the extracted one or more features associated with the set of animals by comparing the extracted one or more features with prestored features corresponding to the set of animals by using the data management-based AI model;
performing at least one of:
detecting one of: a presence and absence of one or more diseases in the set of animals based on the determined one or more retina changes, and predefined disease information by using the data management-based AI model; and
predicting a likelihood of at least one of: the one or more diseases and one or more heath changes in the set of animals based on the determined one or more changes, and the predefined disease information by using the data management-based AI model; and
performing at least one of:
detecting pregnancy status in the set of animals based on the determined one or more changes, and predefined pregnancy information by using the data management-based AI model;
monitoring the pregnancy status in the set of animals based on the determined one or more changes, and the predefined pregnancy information by using the data management-based AI model;
determining scale of optimization associated with the set of animals based on the determined one or more changes, muzzle, beads and ridges of the set of animals by using the data management-based AI model;
detecting dehydration in the set of animals based on one or more dehydration parameters and the determined one or more changes by using the data management-based AI model, wherein the one or more dehydration parameters comprise sunken eyes, drooping skin on face and crusted muzzle;
determining nutritional stress in the set of animals based on one or more stress parameters and the determined one or more changes by using the data management-based AI model, wherein the one or more stress parameters comprise slimming, elongated face and elongated head; and
determining estrous in the set of animals based on one or more estrous parameters and the determined one or more changes by using the data management-based AI model, wherein the one or more estrous parameters comprise flared nostrils, possible glazed eyes and wrinkled nose skin.

18. A computing environment comprising one or snore image capturing devices configured for:
capturing at real-time a multimedia data of a Region of Interest (ROI), wherein the one or more image capturing devices are located at specified locations of the ROI, wherein the multimedia data is indicative of health of one or more animals, and wherein the one or more image capturing devices are located at: at least one of a water pond, next to the water pond, submerged in the water pond, a feeder truck, trailer, pathway to the trailer, loading ramp, unloading ramp, walkway to milking parlor, one or more milking booths, a parlor's railings, a standalone object, body of cattle, one or more animals, chute, a walkway to the chute, a pen, a vehicle and a user; and
uploading the captured multimedia data to at least one of: a central server and one or more on-premises devices.

19. The computing environment of claim 18, further comprising:
receiving at least one of a plurality of images and a plurality of videos from a set of most optimal servers, wherein the one or more plurality of images and the plurality of videos are associated with a set of animals, and wherein the set of animals comprises at least one of: wildlife, livestock and domesticated animals;
extracting one or more body features from the received at least one of a plurality of images and a plurality of videos by using the data management-based AI model;
determining one or more body changes in the extracted one or more body features associated with the set of animals by comparing the one or more body features with prestored body features corresponding to the set of animals by using the data management-based AI model; and
performing at least one of:
detecting pregnancy status in the set of animals based on the determined one or more body changes, and predefined pregnancy information by using the data management-based AI model; and
monitoring the pregnancy status in the set of animals based on the determined one or more body changes, and the predefined pregnancy information by using the data management-based AI model.

20. The computing environment of claim 19, wherein the set of most optimal mobile servers comprises at least one of one or more drones, one or more water-surface robots, one or more land robots and one or more under-water robots.
